(19) United States
(12) Patent Application Publication
(10) Pub. No.: US 2012/0035820 A1
(43) Pub. Date: Feb. 9, 2012

(54) METHOD AND DEVICE FOR OPERATING A VEHICLE, IN PARTICULAR A HYBRID VEHICLE

(75) Inventor: Jens-Werner Falkenstein, Aalen (DE)

(73) Assignee: Robert Bosch GMBH, Stuttgart (DE)

(21) Appl. No.: 13/143,295

(22) PCT Filed: Dec. 4, 2009
(86) PCT No.: PCT/EP09/66408

§ 371 Date: Sep. 26, 2011

(30) Foreign Application Priority Data
Jan. 7, 2009 (DE) 10 2009 000 044.5

(51) Int. Cl. B60B 35/12; B60W 20/00

(52) U.S. Cl. 701/69; 180/65.275; 903/915

(57) ABSTRACT

A method is described for operating a vehicle, in particular a hybrid vehicle, in which each of the two axles of the vehicle, which are not mechanically coupled, is driven by at least one drive unit, thus transmitting a torque to the wheels of the respective axle. To make optimal use of the different coefficients of friction of the wheels which occur with different roadway conditions, the rotational speeds of the wheels of both drive axles are ascertained and averaged, a difference being formed from the averaged rotational speeds of the two axles, respectively, and the torque on at least one axle being influenced based on this difference so that differences in the averaged rotational speeds of the wheels are counteracted. Instead of the rotational speed difference, the deviation of this rotational speed difference from a setpoint rotational speed difference may be used, for example, within the scope of ESP. Alternatively, regulation may be performed based on the wheels of an axle, in which case a dedicated drive unit is associated with each wheel.

### FIELD OF THE INVENTION

The present invention relates to a method for operating a vehicle, in particular a hybrid vehicle, in which each of the two axles of the vehicle, which are not mechanically coupled, is driven by at least one drive unit, thus transmitting a torque to the wheels of the respective axle, and a device for carrying out the method.

### BACKGROUND INFORMATION

A generic device is discussed in German patent document DE 35 42 059 C1. The vehicle has a main drive axle which is drivable by an internal combustion engine in a customary manner. When there is increased slip of the wheels of the main drive axle, the wheels of a connectable auxiliary drive axle may be automatically driven with the aid of a separate auxiliary drive unit, in particular an electric motor. This connection is always established in situations when the vehicle may be moving on a slippery surface.

When the vehicle starts to move, different coefficients of friction result at the two drive axles when the wheels of one drive axle are on a slippery surface, for example black ice, and the wheels of the other drive axle are on the paved roadway. If a possible friction is exceeded for the axle on the slippery surface, the wheel speeds of this axle greatly increase, accompanied by a high degree of slip. In many cases the vehicle slides laterally, so that the drive force is either not converted to propulsion at all, or is converted to propulsion with an unintended change in the direction of the vehicle.

The increase in the wheel speeds may be prevented using a traction control system (TCS) which limits the axle drive setpoint torque of the drive axle which on the slippery surface.

### SUMMARY OF THE INVENTION

The method according to the present invention for operating a vehicle, in particular a hybrid vehicle, has the advantage that optimal use may be made of the different coefficients of friction at the two drive axles. As a result of the rotational speeds of the wheels of both drive axles being ascertained and averaged, a difference being formed from the averaged rotational speeds of both axles, and based on this difference the torque of at least one axle being influenced in such a way that differences in the averaged rotational speeds of the wheels are counteracted, optimal traction of the vehicle is achieved by making use of the different coefficients of friction at the drive axles. For vehicles whose drive torques are generated separately by associated drive units, a high degree of slip is thus avoided.

Based on the difference in the rotational speeds, an axle differential torque which, with an opposite algebraic sign, acts on the drive setpoint torques of the two axles is advantageously determined. The drive setpoint torque on the second axle, which is on the solid road surface, is thus increased in order to compensate for the lack of friction at the first drive axle which is on the slippery surface. The overall drive setpoint torque specified by the driver is thus maintained. The predistribution of the torques on the axles is corrected by the regulation. The use of limited slip differentials in the transmissions may thus be dispensed with, thereby saving on system costs.

In one refinement, the overall drive setpoint torque of the axles is divided between the drive setpoint torques of the two axles as a function of the instantaneous driving state of the vehicle. A predistribution of the overall drive torque on the axles, which may constitute either an equal distribution (50:50) or an unequal distribution (40:60, for example), is thus set. The predistribution may be influenced by an operating strategy of the vehicle and/or by a driving dynamics system.

The differences in the averaged rotational speeds of the individual axles are advantageously not compensated for in a steady state. This allows rotational speed differences which result from the vehicle geometry. The driving stability during cornering and the steering willingness are maintained.

In one embodiment, the steady-state lack of compensation is achieved by proportional or proportional-differential feedback of the rotational speed differences to the drive torques of the axles. The effect of this procedure corresponds to a mechanical central differential or an axle differential, which allows rotational speed compensation and which has an increasing blocking effect with increasing rotational speed difference, but which on account of the method according to the present invention may be dispensed with.

In one refinement, the feedback of the averaged rotational speed to the drive torques and/or the intensification of the feedback is/are influenced by the instantaneous driving state. The driving state is a function of numerous factors, such as the overall drive setpoint torque requested by the driver, the steering wheel angle, the brake pedal actuation, the longitudinal and/or transverse acceleration of the vehicle, the yaw rate, and the intervention by electronic stabilizing systems of the vehicle. The regulation is always influenced as a function of the instantaneous occurrence of friction forces at the wheels of the axles, for which reason an optimal driving state is set in every situation.

In particular for braking or for ABS or driving dynamics interventions, decoupling of the axles by reducing or stopping the feedback may be advantageous, for example to allow independent brake slip control or control about the vertical axis of the vehicle. Ascertaining the vehicle speed which is required by the driving dynamics systems may also require decoupling of the axles for motor vehicles having all-wheel drive. Decoupling should occur during recognized maneuvering or parking operations, or when driving using a compact spare tire, while strong coupling occurs for active TCS or process measurement and control (PMC) interventions having more intense feedback of the rotational speed difference to the axle drive torques.

Alternatively, when there is little friction between the wheels and the roadway, the differences in the averaged rotational speeds of the individual axles are compensated for in a steady-state manner. A high level of traction is thus achieved; i.e., the drive force is optimally converted to propulsion. This may be achieved, for example, by proportional-integral feedback or proportional-integral differential feedback of the rotational speed difference. In addition, an effect is thus achieved which is similar to what would be obtained by using a mechanical limited slip differential.

The overall drive setpoint torque, which represents the sum of the drive torques on the axles, is advantageously influenced, in particular limited, by a driving dynamics system. As a result of the described regulation, the use of conventional driving dynamics systems, such as an electronic stability program, which always influence only a summed drive torque of all vehicle wheels, is also possible for vehicles having single-axle drives. Specialized development and manufacture of driving dynamics systems for the particular application in vehicles having single-axle drives may therefore be dispensed with.

In one embodiment, the influencing of the drive torques on the axles by virtue of the difference in the averaged rotational speeds affects an operating strategy of the vehicle. Thus, in a hybrid vehicle, not only the charging strategy for charging the energy store by the internal combustion engine, but also the operating point of the internal combustion engine may be adjusted in an improved manner, and/or the predistribution of the overall drive torque may be influenced.

Another refinement of the exemplary embodiments and/or exemplary methods of the present invention relates to a method for operating a vehicle, in particular a hybrid vehicle, having at least one axle at which the wheels are separately driven by at least one respective drive unit, thereby transmitting the torques thus generated to the wheel, directly or with the aid of a transmission. To be able to make optimal use of the coefficients of friction of the wheels, the rotational speeds of both wheels are ascertained and a difference in the rotational speeds is formed, this difference being used to influence the torque on at least one wheel in such a way that the difference in the rotational speed of the wheels of the axle is counteracted. Optimal traction of the vehicle is thus achieved by making use of the different coefficients of friction at the wheels. For vehicles whose drive torques are separately generated by associated drive units, a higher degree of slip is thus avoided. Based on the difference in the wheel speeds, a wheel differential torque which, with a different algebraic sign, acts on the wheel torques of the wheels in order to reduce the difference in the wheel speeds is advantageously determined. The predistribution of the torques on the wheels is thus corrected. A predefined overall drive setpoint torque on both wheels is maintained. The use of limited slip differentials may thus be dispensed with, thereby saving on component costs.

In one embodiment, a drive setpoint torque specified by the driver is limited to an overall drive setpoint torque on the wheels which is specified by a driving dynamics system. As a result of the described regulation, the use of conventional driving dynamics systems, such as an electronic stability program, which always influences only a summed drive torque on all vehicle wheels, is also possible for vehicles having single-axle drives. Specialized development and manufacture of driving dynamics systems for the particular application in vehicles having single-axle drives may therefore be dispensed with.

In one refinement, the differences in the rotational speeds of the individual wheels are not compensated for in a steady-state manner. Rotational speed differences which result from the vehicle geometry are thus allowed. The driving stability during cornering and the steering willingness are maintained.

The steady-state lack of compensation is advantageously achieved by proportional or proportional-differential feedback of the rotational speed differences to the drive torques of the wheels. The driving state is a function of numerous factors, such as the overall drive setpoint torque requested by the driver, the steering wheel angle, the brake pedal actuation, the longitudinal and/or transverse acceleration of the vehicle, the yaw rate, and the intervention of electronic stabilizing systems of the vehicle. The regulation is always influenced as a function of the instantaneous occurrence of friction forces at the wheels, for which reason an optimal driving state is set in every situation.

In particular for braking or for ABS or driving dynamics interventions, decoupling of the wheels by reducing or stopping the feedback may be advantageous, for example to allow independent brake slip control of the individual wheels. Ascertaining the vehicle speed, which is required by the driving dynamics systems, may also require decoupling of the wheels for motor vehicles having all-wheel drive. Decoupling should occur during recognized maneuvering or parking operations, or when driving using a compact spare tire, while strong coupling occurs for active TCS or PMC interventions having more intense feedback of the rotational speed difference to the wheel drive torques.

In one embodiment, the feedback of the difference in the rotational speed of the wheels to the drive torques of the wheels and/or the intensification of the feedback is/are influenced by the instantaneous driving state. In particular for braking, for ABS, or for driving dynamics interventions, decoupling of the wheels by reducing or stopping the feedback may be advantageous, for example to allow control about the vertical axis of the vehicle.

Alternatively, when there is little friction between the wheels and the roadway, the differences in the rotational speeds of the individual wheels are compensated for in a steady-state manner. A high level of traction is thus achieved. This may be achieved, for example, by proportional-integral feedback or proportional-integral differential feedback of the rotational speed difference. In addition, an effect is thus achieved which is similar to what would be obtained by using a mechanical limited slip differential.

Another refinement of the exemplary embodiments and/or exemplary methods of the present invention relates to a device for operating a vehicle, in particular a hybrid vehicle, in which each of the axles of the hybrid vehicle, which are not mechanically coupled, is driven by at least one drive unit, thus transmitting a torque to the wheels of the respective axle. In order to make better use of different coefficients of friction at the drive axles, a measuring arrangement measures the rotational speeds of the wheels of both drive axles and average same, then form a difference of the averaged rotational speeds of both axles, and use this difference to influence the torque on at least one axle in such a way that differences in the averaged rotational speeds of the wheels of an axle are counteracted. The device has the advantage that optimal traction of the vehicle is achieved by making optimal use of the different coefficients of friction at the drive axles. For vehicles whose drive torques are generated separately by associated drive units, a high degree of slip is thus avoided.

One rotational speed sensor advantageously measures the rotational speed of each wheel of an axle, the two rotational speed sensors for an axle each leading to an averaging unit, and the two averaging units being connected to a controller which determines an axle differential torque based on the difference in the rotational speeds, and which outputs this differential torque, with an opposite algebraic sign, to the drive setpoint torques of the two axles. As a result of this regulation, the distribution of the torques on the individual axles is corrected and adapted to the instantaneous roadway conditions. The use of a mechanical limited slip differential may be dispensed with.

In one embodiment, a drive force setpoint generator, a driver assistance system, and/or a driving dynamics system is/are connected to a limiter which outputs a drive setpoint torque and which leads to at least one drive unit of at least one axle. The overall drive setpoint torque is thus set, either by the driver or by the driving dynamics system, to a specified value which is distributed on the two drive axles in equal or unequal portions, depending on the driving state.

In one refinement, an operating strategy element is connected between the limiter and the drive unit. In such an operating strategy element, an axle drive setpoint torque is converted to the gear ratio of a transmission.

The limiter is advantageously connected to two drive units, each drive unit controlling a wheel, directly or with the aid of a transmission, and the two wheels are situated in an axle-free manner, two rotational speed sensors which detect the rotational speed of each wheel being connected to a summer which forms a difference, and which leads to a second controller which generates a wheel differential torque, and which outputs the wheel differential torque, with an opposite algebraic sign, to the torques of the two drive units of the wheels.

Optimal traction of the vehicle is thus achieved by making use of the different coefficients of friction at the wheels. The device has a second controller which makes optimal use of the different coefficients of friction of the two wheels. In interaction with the first controller which regulates the drive torque on an axle and the drive torque on the two wheels regulated by the second controller, a very flexible system is obtained for controlling drive axles or drive wheels which are not mechanically coupled.

The exemplary embodiments and/or exemplary methods of the present invention allows numerous design options. One of these design options is explained in greater detail with reference to the wheels illustrated in the drawings.

### BRIEF DESCRIPTION OF THE DRAWINGS

FIG. 1 shows a device for driving drive axles, which are not mechanically coupled, according to the related art.

FIG. 2 shows a first exemplary embodiment of a device for regulating drive axles which are not mechanically coupled.

FIG. 3 shows a schematic flow chart for the device according to FIG. 2.

FIG. 4 shows a second exemplary embodiment of a device for regulating drive wheels which are not mechanically coupled.

FIG. 5 shows a schematic flow chart for the device according to FIG. 4.

### DETAILED DESCRIPTION

Identical features are denoted by the same reference numerals.

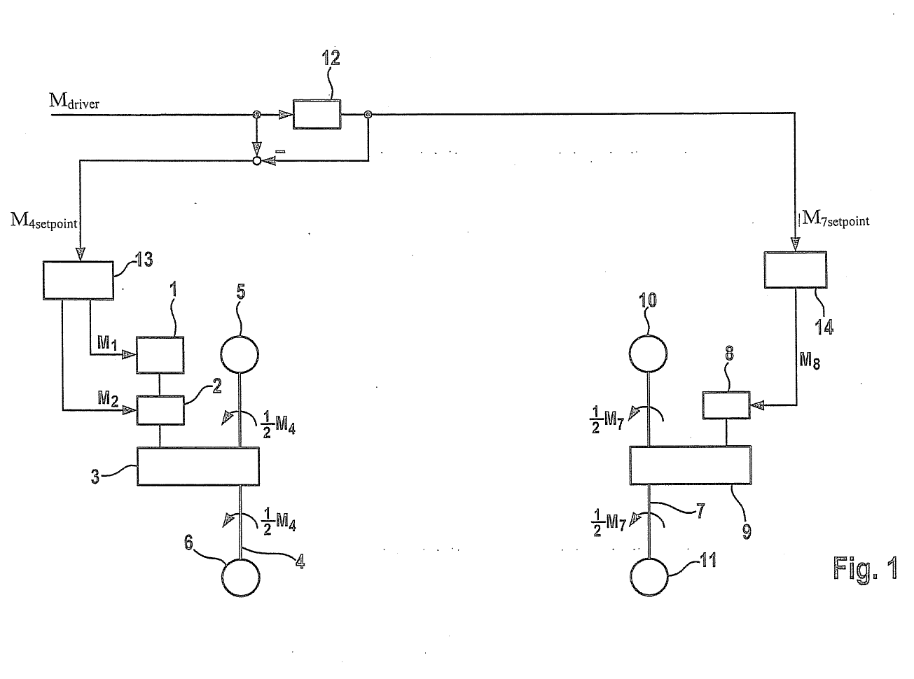

FIG. 1 shows a drive train of a hybrid vehicle. An internal combustion engine 1 is coupled to a first electric motor 2, which leads to a first transmission 3. Transmission 3 is connected to a first axle 4 on which two wheels 5, 6 are situated. Torque M₁ of internal combustion engine 1 and torque. M₂ of first electric motor 2 are added to form a drive torque which is converted by transmission 3. An axle drive torque M₄ of first drive axle 4 results at the output of transmission 3; the first drive axle may be the front axle of the vehicle, for example. This drive torque M₄ is relayed to drive wheels 5, 6.

A second drive axle 7 is driven by a second electric motor 8, which generates drive torque M₈. Drive torque M₈ is converted with the aid of a second transmission 9, and is relayed to wheels 10, 11 as axle drive torque M₇ of second drive axle 7.

Both transmissions 3 and 9 contain axle differentials, so that the sum of the two wheel torques corresponds to axle drive torque M₄ or M₇, respectively. In most driving situations an axle drive torque is equally distributed over the two wheel torques.

The driver or a driver assistance system specifies an overall drive setpoint torque M_{driver} which is distributed, via a distributor 12 according to a distribution factor α, to axle drive setpoint torques M₄ₛₑₜₚₒᵢₙₜ and M₇ₛₑₜₚₒᵢₙₜ of the two drive axles 4, 7, respectively. Distribution factor α is influenced by the operating strategy of the vehicle. A driving dynamics system may also influence distribution factor α. An element 13 for determining the operating strategy converts axle drive setpoint torque M₄ₛₑₜₚₒᵢₙₜ, using the gear ratio of transmission 3, and distributes it over electric motor 2 having torque M₂ and internal combustion engine 1 having torque M₁. By use of this distribution, a charging strategy for an electrical energy store, not illustrated in greater detail, which implements boost and recuperation operations, among others, is achieved. In total, an axle drive torque M₄ results at drive wheels 5, 6 which approximately corresponds to axle drive setpoint torque M₄ₛₑₜₚₒᵢₙₜ.

Second element 14 for an operating strategy uses the gear ratio of transmission 9 to torque M₈ of electric motor 8 to convert axle drive setpoint torque M₇ₛₑₜₚₒᵢₙₜ for second drive axle 4. In total, an axle drive torque M₇ which approximately corresponds to axle drive setpoint torque M₇ₛₑₜₚₒᵢₙₜ results at drive wheels 10, 11.

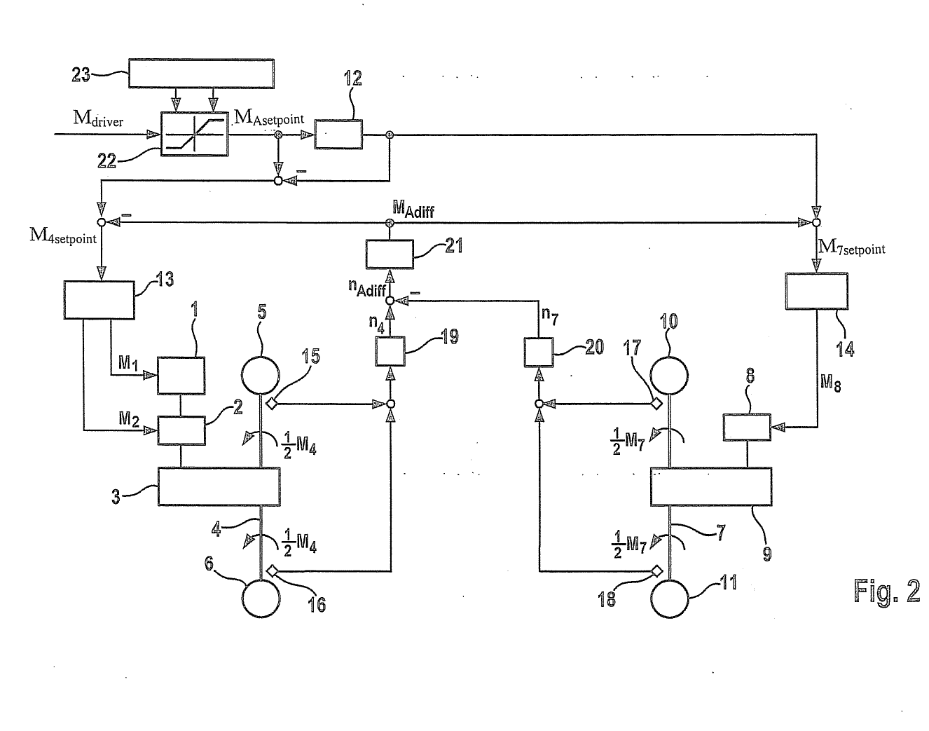

FIG. 2 illustrates a first exemplary embodiment of the present invention. Internal combustion engine 1, first electric motor 2, and transmission 3 are the same as described in FIG. 1, drive axle 4 being associated with wheels 5, 6. The same applies for second electric motor 8, which is associated with transmission 9 of second drive axle 7, and therefore associated with wheels 10, 11.

The wheel speeds of wheels 5, 6 and 10, 11 are detected by sensors. Sensor 15 is situated opposite wheel 5, sensor 16 is opposite wheel 6, sensor 17 is opposite wheel 10, and sensor 18 is opposite wheel 11. Sensors 15, 16 are connected to an averaging unit 19, and sensors 17, 18 are connected to an averaging unit 20. Both averaging units lead to a first controller 21.

A limiter 22 which receives input signals from the driver, from a driver assistance system, and from a driving dynamics system 23 is situated upstream from distributor 12.

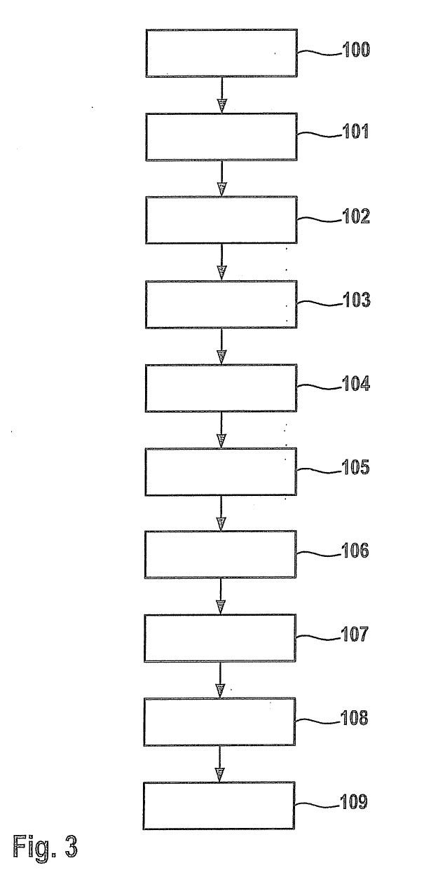

The sequence of the method is explained with the aid of FIG. 3. In block 100 the vehicle starts to move, with different coefficients of friction at the two drive axles 4 and 7. This means that wheels 5, 6 of one drive axle 4 are on a slippery surface, such as black ice, while wheels 10, 11 of second drive axle 7 are on pavement. In block 101 rotational speeds n of each wheel 5, 6 and 10, 11 are measured by sensors 15, 16, 17, 18. In block 102 rotational speeds n of wheels 5, 6 of first drive axle 4 are averaged in averaging unit 19, and a rotational speed average value n₄ is obtained. Rotational speeds n of wheels 10, 11 of second drive axle 7 are averaged in averaging unit 20 to form a rotational speed average value n₇. For the described roadway conditions, rotational speed average value n₄ increases compared to rotational speed average value n₇ as a result of the black ice.

Rotational speed average value n₇ of second axle 7 which is ascertained in this way, having an opposite algebraic sign, is combined with rotational speed average value n₄ of first axle 4 (block 103). This results in an axle rotational speed difference n_{Adiff}, which is supplied to controller 21 in block 104. When controller 21 is supplied with a positive axle rotational speed difference n_{Adiff}, as is the case in the described start-up situation, controller 21 generates a positive axle differential torque M_{Adiff}. In block 105 this axle differential torque M_{Adiff} is supplied to axle drive setpoint torque M₄ₛₑₜₚₒᵢₙₜ with a negative algebraic sign, while it is supplied to axle drive setpoint torque M₇ₛₑₜₚₒᵢₙₜ with a positive algebraic sign. When axle differential torque M_{Adiff} is positive, in block 106 this results in a decrease in axle drive setpoint torque M₄ₛₑₜₚₒᵢₙₜ for first axle 4, and an increase in axle drive setpoint torque M₇ₛₑₜₚₒᵢₙₜ on second drive axle 7, which counteracts rotational speed difference n_{Adiff}. Overall drive setpoint torque M_{driver} specified by the driver is thus maintained.

If it is determined in block 107 that the two drive axles 4, 7 have excessively high slip, driving dynamics system 23 or a TCS system, not illustrated in greater detail, is activated in block 108. Overall drive setpoint torque M_{driver} is reduced by limiter 22, resulting in an overall machine drive setpoint torque M_{Asetpoint} which is less than overall drive setpoint torque M_{driver} which has been requested by the driver. This means that overall machine drive setpoint torque M_{Asetpoint} is not reduced compared to the overall drive setpoint torque specified by the driver until optimal use has already been made of the different coefficients of friction at the two drive axles 4, 7, which ensures good traction. Also during the intervention by the TCS system or driving dynamics system 23, the regulation and therefore the optimal distribution of the two drive setpoint torques M₄ₛₑₜₚₒᵢₙₜ and M₇ₛₑₜₚₒᵢₙₜ remains active.

By recognition of an appropriate driving situation or by specification by the driver, an integral portion of controller 21 which compensates for axle rotational speed difference n_{Adiff} in a steady-state manner or regulates same to zero is enabled in block 109. The traction of the vehicle is optimized in this way.

Not illustrated in greater detail is a taking into account of axle differential torque M_{Adiff} in operating strategy element 13 which, corresponding to increased axle drive setpoint torque M₇ₛₑₜₚₒᵢₙₜ and the resulting increase in the power requirements of second electric motor 8, shifts the operating points of first electric motor 2, having torque M₂, and of internal combustion engine 1, having torque M₁, in order to generate more electrical power. Likewise not illustrated is an influencing of distribution factor α by axle differential torque M_{Adiff}. If it is not possible to maintain a distribution factor α specified by the operating strategy on account of the instantaneous roadway friction conditions or the instantaneous driving state, this results in a longer intervention by controller 21 with the aid of axle differential torque M_{Adiff}. Such an intervention is used to correct distribution factor α, and therefore the predistribution, for a fairly long period of time, and thus to terminate the intervention.

As an alternative to averaging the wheel speeds on the basis of the axles, the rotational speeds of electric motors 2, 8 or of internal combustion engine 1 may be used, taking the transmission gear ratios into account. Slip at transmission elements, for example at a starting clutch or a torque converter, must likewise be taken into account.

Dedicated control units which communicate with one another via bus connections are usually used for internal combustion engine 1 and electric motors 2 and 8. In that case it is meaningful to ascertain axle differential torque M_{Adiff} or wheel differential torque M_{Rdiff} at the same time in multiple control units in order to allow the feedback of a rotational speed to a setpoint torque, without, or with the smallest possible, time delays as a result of the bus systems.

In FIG. 2, rotational speed n₇ of second drive axle 7 may be computed from the rotational speed of second electric motor 8 which is present in the control unit of second electric motor 8. Axle differential torque M_{Adiff}, the feedback to axle drive setpoint torque M₇ₛₑₜₚₒᵢₙₜ and operating strategy element 14 are then likewise computed in the control unit of second electric motor 8. The total signal flow from the rotational speed of second electric motor 8 to setpoint torque M₈ of second electric motor 8 is then present in the control unit of second electric motor 8. The signal flow does not occur via a bus connection, and therefore does not have time delays, which improves the control quality. A corresponding procedure may be selected for the control unit of internal combustion engine 1 and the control unit of first electric motor 2. Algorithms of operating strategy element 13 must likewise be computed simultaneously in these two control units.

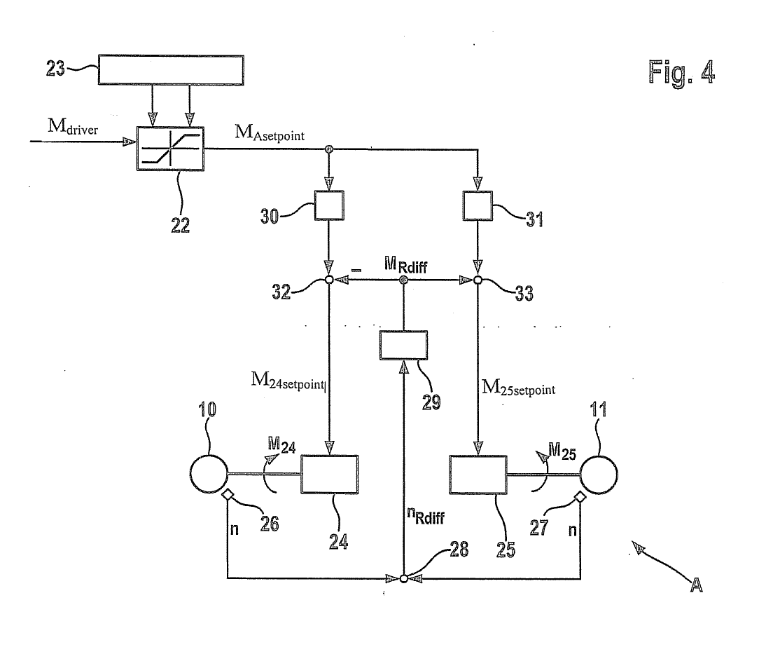

FIG. 4 illustrates a device for regulating drive wheels which are not mechanically coupled. Wheel 10 is driven by an electric motor 24, and wheel 11 is driven by an electric motor 25. A rotational speed sensor 26 is situated opposite wheel 10, and a rotational speed sensor 27 is opposite wheel 11. Both rotational speed sensors 26 and 27 are connected to a second controller 29 via a summer 28. In this design as well, signals from the driver and/or from a driving dynamics system 23 are directed to a limiter 22, whose output signal is supplied to each of distributors 30, 31. Distributor 30 is connected via summation point 32 to electric motor 24 which drives first wheel 10, while second distributor 31 is led via summation point 33 to electric motor 25 which drives wheel 11.

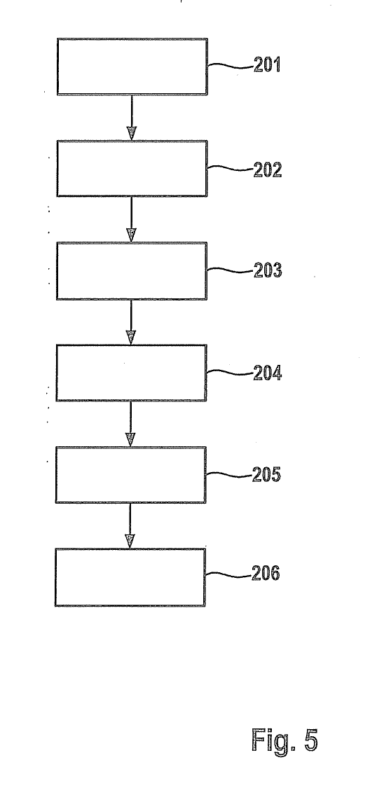

The mode of operation of this device is illustrated in FIG. 5. The driver outputs an overall drive setpoint torque M_{driver} in block 201. A drive setpoint torque M_{Asetpoint} for wheels 10, 11 results from limiting overall drive setpoint torque M_{driver} specified by the driver, to a torque limit in limiter 22 which is specified by driving dynamics system 23. In block 202 this drive setpoint torque M_{Asetpoint} is directed to the two distributors 30, 31, which divide drive setpoint torque M_{Asetpoint} in half, electric motor 24 being supplied with setpoint torque M₂₄ₛₑₜₚₒᵢₙₜ by distributor 30, and electric motor 25 being supplied with setpoint torque M₂₅ₛₑₜₚₒᵢₙₜ by distributor 31. Setpoint torque M₂₄ₛₑₜₚₒᵢₙₜ and M₂₅ₛₑₜₚₒᵢₙₜ approximately correspond to the wheel torques of wheels 10, 11 which are driven by the respective electric motor.

Actual wheel speeds n of wheels 10, 11, which are based on the actual conditions of the state of the vehicle and the surface beneath the vehicle, are measured in block 203. In block 204, summer 28 uses measured wheel speeds n to form a wheel speed difference n_{Rdiff}, which is supplied to controller 29. In block 205, controller 29 forms a wheel differential torque M_{Rdiff} based on wheel speed difference n_{Rdiff}. This wheel differential torque M_{Rdiff} is included in block 206 with a negative algebraic sign, resulting in setpoint torque M₂₄ₛₑₜₚₒᵢₙₜ. Setpoint torque M₂₅ₛₑₜₚₒᵢₙₜ results from addition of wheel differential torque M_{Rdiff} with a positive algebraic sign. A rotational speed difference n_{Rdiff} is counteracted in this way. For multiple driven axles, drive axle A from FIG. 4 may replace drive axle 7 from FIG. 2, for example. Drive setpoint torque M_{Asetpoint} in FIG. 4 then corresponds to axle drive setpoint torque M₇ₛₑₜₚₒᵢₙₜ in FIG. 2. Both controllers 21 and 29 are used, controller 21 counteracting the differences in the averaged wheel speeds of individual drive axles 4, 7, and controller 29 counteracting the differences in the wheel speeds of axle A.

As an alternative to the wheel speeds, the rotational speeds of the electric motors may be used, possibly taking transmission gear ratios into account.

In both exemplary embodiments, possible operating ranges of the units, such as electric motors, internal combustion engines, an electrical energy store, among others, must be maintained. For example, based on a positive overall drive setpoint torque M_{driver} which is specified by the driver, no increase is allowed in the total generated drive torque as a result of the unit limitations.

It is also possible for axle drive setpoint torques M₄ₛₑₜₚₒᵢₙₜ and M₇ₛₑₜₚₒᵢₙₜ from FIG. 2, which already include differential torque M_{Adiff}, to be influenced or limited separately with the aid of the driving dynamics system, thus allowing, for example, the self-guidance behavior or control about the vertical axis of the vehicle to be optimized in a targeted manner.

Likewise, setpoint torques M₂₄ₛₑₜₚₒᵢₙₜ and M₂₅ₛₑₜₚₒᵢₙₜ from FIG. 4, which already include wheel differential torque M_{Rdiff}, may be separately influenced with the aid of the driving dynamics system.

When there is zero crossing of an axle drive setpoint torque M₄ₛₑₜₚₒᵢₙₜ, M₇ₛₑₜₚₒᵢₙₜ or of setpoint torque M₂₄ₛₑₜₚₒᵢₙₜ, M₂₅ₛₑₜₚₒᵢₙₜ a transition occurs between coasting mode and traction mode of the axle or the wheel. Mechanical slack occurs in the transmission or in the articulated joints of the drive shafts. The zero crossing of the reaction torque also causes the engine to tilt in its bearings, which may result in load impacts. For comfort reasons, a zero crossing should occur smoothly, which is achieved by limiting the dynamics of the axle drive setpoint torque or of the setpoint torque during its zero crossing, for example by gradient limitation. In one refinement, the dynamics of axle drive setpoint torques M₄ₛₑₜₚₒᵢₙₜ, M₇ₛₑₜₚₒᵢₙₜ and/or of setpoint torques M₂₄ₛₑₜₚₒᵢₙₜ, M₂₅ₛₑₜₚₒᵢₙₜ are limited in the range around 0 Nm, for example in a range of −100 Nm to +100 Nm.

Setpoint rotational speed differences have not been described in the exemplary embodiments illustrated above; i.e., it has been assumed that setpoint rotational speed differences n_{Adiffsetpoint} and n_{Rdiffsetpoint} are equal to 0 rpm.

In one refinement, in FIG. 2, instead of axle rotational speed difference n_{Adiff}, a deviation n_{Adelta} of axle rotational speed difference n_{Adiff} from a setpoint rotational speed difference n_{Adiffsetpoint} is supplied to controller 21

n_{Adelta}=n_{Adiff}−n_{Adiffsetpoint}

In FIG. 4, instead of wheel speed difference n_{Rdiff}, a deviation n_{Rdelta} of wheel speed difference n_{Rdiff} from a setpoint rotational speed difference n_{Rdiffsetpoint} may be supplied to controller 29

n_{Rdelta}=n_{Rdiff}−n_{Rdiffsetpoint}

The setpoint rotational speed differences n_{Adiffsetpoint} and n_{Rdiffsetpoint} are ascertained based on an instantaneous driving state and/or a desired setpoint driving state of the vehicle, for example based on the requested overall drive torque, the steering wheel angle, the brake pedal activation, the longitudinal and/or transverse acceleration of the vehicle, the yaw rate, and/or the vehicle speed. Conditions of the surroundings, such as roadway friction conditions, may also be taken into account.

Setpoint rotational speed differences n_{Adiffsetpoint} and n_{Rdiffsetpoint} are computed by a driving dynamics system or an electronic stabilizing system of the vehicle, for example, and thus specify that the instantaneous driving state of the vehicle approximates the setpoint driving state. This results in comfortable influencing of axle drive setpoint torques M₄ₛₑₜₚₒᵢₙₜ, M₇ₛₑₜₚₒᵢₙₜ or of setpoint torques M₂₄ₛₑₜₚₒᵢₙₜ, M₂₅ₛₑₜₚₒᵢₙₜ in which sum M₄ₛₑₜₚₒᵢₙₜ+M₇ₛₑₜₚₒᵢₙₜ of the axle drive torques or sum M₂₄ₛₑₜₚₒᵢₙₜ+M₂₅ₛₑₜₚₒᵢₙₜ of the setpoint torques is not changed. A high level of driving dynamics may also be provided in this way. At the same time, the instantaneous driving state is corrected, for example to stabilize skidding motions. Deviations n_{Adelta} of the axle rotational speed difference and n_{Rdelta} of the wheel speed difference may be compensated for in a steady-state manner, or not compensated for in a steady-state manner, depending on the instantaneous driving state and the desired setpoint driving state.

By use of the setpoint rotational speed differences, for example, different axle and wheel speeds during cornering may be taken into account, based on the vehicle geometry or different wheel diameters. Controllers 21, 29 adapt the instantaneous axle rotational speed difference and/or the instantaneous wheel speed difference to the setpoint rotational speed differences, which has a stabilizing effect on the driving dynamics.

The instantaneous driving state influences the behavior of controller 21 or of controller 29. Controller parameters, the behavior in the large and small signal ranges, and/or a controller dead band are adapted to the instantaneous driving state.

The regulation illustrated in FIG. 2 is advantageously active when only one axle is driven, for example when the vehicle in electric driving mode is driven only by second electric motor 8, and internal combustion engine 1 together with first electric motor 2 is decoupled by engaging a neutral gear in transmission 3. Large slip differences between driven axle 7 and nondriven first axle 4 are then avoided.

The regulation may also be used for actively damping drive train vibrations in which one wheel/axle vibrates against another axle/wheel, for example for vibration excitation resulting from an uneven roadway, from interventions of a driving dynamics or braking system, from the starting or switching off of internal combustion engine 1, from sudden changes in the roadway friction conditions, or from shifting of the transmission.

1-25. (canceled)

26. A method for operating a vehicle, which is a hybrid vehicle, in which each of two axles of the vehicle, which are not mechanically coupled, is driven by at least one drive unit, so as to transmit a torque to the wheels of a respective axle, the method comprising:
ascertaining and averaging rotational speeds of the wheels of both of the drive axles;
forming a difference from the averaged rotational speeds of the two axles, respectively; and
influencing a torque on at least one axle is influenced based on this difference so that the difference in the averaged rotational speeds of the wheels is counteracted.

27. The method of claim 26, wherein an axle differential torque which, with an opposite algebraic sign, acts on the drive setpoint torques of the two axles is determined based on the difference in the rotational speeds.

28. The method of claim 27, wherein a drive setpoint torque specified by the driver is limited to an overall machine drive setpoint torque on the axles which is specified by a driving dynamics system.

29. The method of claim 27, wherein the overall machine drive setpoint torque of the axles is divided between the drive setpoint torques of the two axles as a function of the instantaneous driving state of the vehicle.

30. The method of claim 26, wherein the difference in the averaged rotational speeds of the individual axles is not compensated for in a steady-state manner.

31. The method of claim 31, wherein the steady-state lack of compensation is achieved by proportional or proportional-differential feedback of the rotational speed difference to the drive torques of the axles.

32. The method of claim 31, wherein at least one of a feedback of the averaged rotational speeds to the drive torques and an intensification of the feedback is influenced by an instantaneous driving state.

33. The method of claim 26, wherein, when there is little friction between the wheels and the roadway, the difference in the averaged rotational speeds of the individual axles is compensated for in a steady-state manner.

34. The method of claim 28, wherein the overall machine drive setpoint torque, which represents a sum of the drive torques on the axles, is influenced, so as to be limited, by a driving dynamics system.

35. The method of claim 26, wherein the influencing of the drive torques on the axles by virtue of the difference in the averaged rotational speeds affects an operating strategy of the vehicle.

36. The method of claim 26, wherein the rotational speed difference of the axles is replaced by a deviation of the axle rotational speed difference from a setpoint rotational speed difference.

37. A method for operating a vehicle, which is a hybrid vehicle, having at least one axle at which the wheels are separately driven by at least one drive unit, respectively, so as to transmit the thus generated torques to the wheel, directly or with the aid of a transmission, the method comprising:
ascertaining rotational speeds of both wheels;
forming a difference in the rotational speeds; and
influencing a torque on at least one wheel based on this difference so that the difference in the rotational speed of the wheels of the axle is counteracted.

38. The method of claim 37, wherein a wheel differential torque which, with a different algebraic sign, acts on the wheel torques of the wheels of the axle is determined based on the difference in the wheel speeds to reduce the difference in the wheel speeds.

39. The method of claim 38, wherein a drive setpoint torque specified by the driver is limited to an overall machine drive setpoint torque on the wheels which is specified by a driving dynamics system.

40. The method of claim 37, wherein the difference in the rotational speeds of the individual wheels is not compensated for in a steady-state manner.

41. The method of claim 40, wherein the steady-state lack of compensation is achieved by proportional or proportional-differential feedback of the rotational speed difference to the drive torques of the wheels.

42. The method of claim 41, wherein at least one of a feedback of the difference in the rotational speed of the wheels to the drive torques of the wheels and an intensification of the feedback is influenced by an instantaneous driving state.

43. The method of claim 37, wherein, when there is little friction between the wheels and the roadway, the difference in the rotational speeds of the individual wheels is compensated for in a steady-state manner.

44. The method of claim 39, wherein the setpoint torques of the wheels are separately influenced with the aid of the driving dynamics system.

45. The method of claim 37, wherein the rotational speed difference of the wheels is replaced by a deviation of the wheel speed difference from a setpoint rotational speed difference.

46. A device for operating a vehicle, which is a hybrid vehicle, in which each of two axles of the vehicle, which are not mechanically coupled, is driven by at least one drive unit, so as to transmit a torque to the wheels of a respective axle, comprising:
a rotational speed arrangement to ascertain rotational speeds of the wheels of both drive axles and average the rotational speeds so as to provide averaged rotational speeds of both axles;
a difference arrangement to form a difference of the averaged rotational speeds of both axles; and
an influencing arrangement to influence a torque on at least one axle based on this difference so that the difference in the averaged rotational speeds of the wheels of an axle is counteracted.

47. The device of claim 46, wherein one rotational speed sensor measures the rotational speed of each wheel, respectively, of an axle, the two rotational speed sensors for an axle each leading to an averaging unit, and wherein the two averaging units are coupled to a controller which determines a differential torque based on the difference in the rotational speeds, and which outputs this differential torque, with an opposite algebraic sign, to the drive setpoint torques of the two axles.

48. The device of claim 46, wherein at least one of a drive force setpoint generator and a driving dynamics system is coupled to a limiter which outputs a drive setpoint torque and which leads to at least one drive unit of at least one axle.

49. The device of claim 47, wherein an operating strategy element is coupled between the limiter and the drive unit.

50. The device of claim 47, wherein the limiter is coupled to two drive units, each of the drive units controlling a wheel, directly or with the aid of a transmission, and the two wheels being situated in an axle-free manner, wherein two rotational speed sensors which detect the rotational speed of each wheel are coupled to a summer which forms a difference, and which leads to a second controller which generates a wheel differential torque, and which outputs the wheel differential torque, with an opposite algebraic sign, to the torques of the two drive units of the wheels.
